(19) United States
(12) Patent Application Publication
(10) Pub. No.: US 2019/0071967 A1
(43) Pub. Date: Mar. 7, 2019

(54) DESIGN METHOD FOR MINING UPPER PROTECTIVE SEAM CLOSE TO TOTAL ROCK FOR USE IN COAL-BED MINING

(71) Applicant: CHINA UNIVERSITY OF MINING AND TECHNOLOGY

(72) Inventors: Jixiong ZHANG, Jiangsu (CN); Qiang ZHANG, Jiangsu (CN); Qiang SUN, Jiangsu (CN); Xiancheng MEI, Jiangsu (CN)

(73) Assignee: CHINA UNIVERSITY OF MINING AND TECHNOLOGY, Jiangsu (CN)

(21) Appl. No.: 15/767,132

(22) PCT Filed: Nov. 18, 2016
(86) PCT No.: PCT/CN2016/106341

§ 371 Date: Apr. 9, 2018

(30) Foreign Application Priority Data
Apr. 29, 2016 (CN) 201610278563.6

(51) Int. Cl. E21B 49/02; E21C 41/18; E21F 7/00; G06F 17/50

(52) U.S. Cl. CPC E21B 49/02; G06F 17/5009; E21F 7/00; E21C 41/18

(57) ABSTRACT

A mining design method for an upper protective layer in coal seam mining, and provides a mining design method for a near-whole rock upper protective layer. Based on information about engineering geologic conditions of a protective layer mining well and physico-mechanical parameters of a coal-rock mass sample, a protective layer mining thickness M and an interval H between the protective layer and the protected layer are determined by means of numerical analysis such that an expansion deformation rate φ of a protected layer, a failure depth K of a floor plastic zone of a protective layer, and a coal seam gas pressure P meet the Provision in Prevention and Control of Coal and Gas Outburst. Then, according to a mining thickness percentage accounted by rock in the near-whole rock upper protective layer, a mining process of the near-whole rock protective layer is determined from among a traditional fully-mechanized coal mining process, a traditional fully-mechanized coal mining process assisted by single-row hole pre-splitting blasting, and a traditional fully-mechanized coal mining process assisted by double-row twisted hole blasting. This method provides a theoretical basis for safe mining of a low-permeability gas-rich coal seam without a regular protective layer, and further enriches mining design methods with a protective layer. This method is economically efficient, safe and efficient, and has a wide applicability.

### BACKGROUND

### Technical Field

The present invention relates to a mining design method for an upper protective layer in coal seam mining, and in particular, to a mining design method for a near-whole rock upper protective layer in coal seam mining.

### Description of Related Art

In mining technology of a gas-rich coal seam, generally, a protective layer is first mined for pressure-relief gas drainage, and then a protected layer is mined. Gas pressure-relief of a coal seam as the protected layer is effectively performed by mining of an upper protective layer, overlying strata movement, and gas drainage of the protected layer through boreholes. Currently, because the upper protective layer may not contain a traditional minable coal seam as protected layer, an accurate mining design method for a near-whole rock upper protective layer with a high refuse content has not yet emerged. A protective layer mining process is a crucial factor affecting mining of the near-whole rock upper protective layer. Therefore, by researching a mining thickness of the near-whole rock upper protective layer and an interval between the protective layer and the protected layer, and according to a mining thickness percentage accounted by rock in the near-whole rock upper protective layer, a mining process of the near-whole rock protective layer is determined from among a traditional fully-mechanized coal mining process, a traditional fully-mechanized coal mining process assisted by single-row hole pre-splitting blasting, and a traditional fully-mechanized coal mining process assisted by twisted hole blasting. Such mining process is of great significance to safe mining of a gas-rich coal seam.

### SUMMARY OF THE INVENTION

Technical Problem:

An objective of the present invention is to provide an economically efficient, safe and reliable mining design method for a near-whole rock upper protective layer in coal seam mining, so as to solve an existing problem in mining of a low-permeability gas-rich coal seam without a regular protective layer.

Technical Solution:

In the mining design method for a near-whole rock upper protective layer in coal mining of the present invention, based on information about engineering geologic conditions of a protective layer mining well and physico-mechanical parameters of a coal-rock mass sample, a protective layer mining thickness M and an interval H between the protective layer and the protected layer are determined by means of numerical analysis such that an expansion deformation rate φ of a protected layer, a failure depth K of a floor plastic zone of a protective layer, and a coal seam gas pressure P meet the Provision in Prevention and Control of Coal and Gas Outburst. Then, according to a mining thickness percentage accounted by rock in the near-whole rock upper protective layer, a mining process of the near-whole rock protective layer is determined from among a traditional fully-mechanized coal mining process, a traditional fully-mechanized coal mining process assisted by single-row hole pre-splitting blasting, and a traditional fully-mechanized coal mining process assisted by double-row twisted hole blasting. Specific steps are as follows:

(1) collecting information about engineering geologic conditions of a protective layer mining well, and sampling a coal-rock mass;

(2) fabricating a standard sample from the sampled coal-rock mass, and performing a rock mechanics test, to obtain physico-mechanical parameters of the coal-rock mass;

(3) according to the information about the engineering geologic conditions of the protective layer mining well and the physico-mechanical parameters of the coal-rock mass, establishing a coal-mining numerical model for the near-whole rock upper protective layer by using finite element analysis software FLAC^{3D};

(4) calculating and analyzing, in a simulated manner, changes of an expansion deformation rate of a protected layer, a failure depth K of a floor plastic zone of a protective layer, and a coal seam gas pressure P under respective conditions that an interval H between the protective layer and the protected layer is not changed and a protective layer mining thickness M is changed, or the protective layer mining thickness M is not changed and the interval H between the protective layer and the protected layer is changed;

(5) based on a result of the simulated calculation, determining a desired protective layer mining thickness M and a desired interval H between the protective layer and the protected layer; and

(6) according to a mining thickness percentage accounted by rock in the near-whole rock upper protective layer, determining a mining process of the near-whole rock protective layer from among a traditional fully-mechanized coal mining process, a traditional fully-mechanized coal mining process assisted by single-row hole pre-splitting blasting, and a traditional fully-mechanized coal mining process assisted by twisted hole blasting.

The near-whole rock upper protective layer is located above the protected layer, and has a refuse content of up to 80% when a mining thickness of the protective layer is 1.5 m to 3.0 m.

Advantageous effect: With the mining design method for a near-whole rock upper protective layer, in an actual application, it is only required to determine an upper protective layer mining thickness and an interval between a protective layer and a protected layer, and then a mining process of the near-whole rock protective layer can be determined according to a thickness percentage occupied by rock mining in mining of the near-whole rock protective layer. This method offers a reference for a mining design for the upper protective layer, and provides a theoretical basis for safe mining of a gas-rich coal outburst mine. This method is economically efficient, safe and efficient, and has a wide applicability.

### BRIEF DESCRIPTION OF THE DRAWINGS

FIG. 1 is a flowchart of a mining design method for a near-whole rock upper protective layer according to the present invention;

FIG. 2 shows a numerical calculation model for mining of a near-whole rock upper protective layer according to the present invention;

FIG. 3 is a graph showing changes of expansion deformation of a protected layer according to the present invention;

FIG. 4 is a graph showing changes of a failure depth of a floor plastic zone of a protective layer according to the present invention;

FIG. 5 is a bar chart showing changes of a gas pressure of a coal seam according to the present invention;

FIG. 6 is a diagram showing an arrangement of single-row blast holes according to the present invention; and

FIG. 7 is a diagram showing an arrangement of double-row twisted blast holes according to the present invention.

### DETAILED DESCRIPTION OF THE EMBODIMENTS

One embodiment of the present invention is further described below with reference to the accompanying drawings.

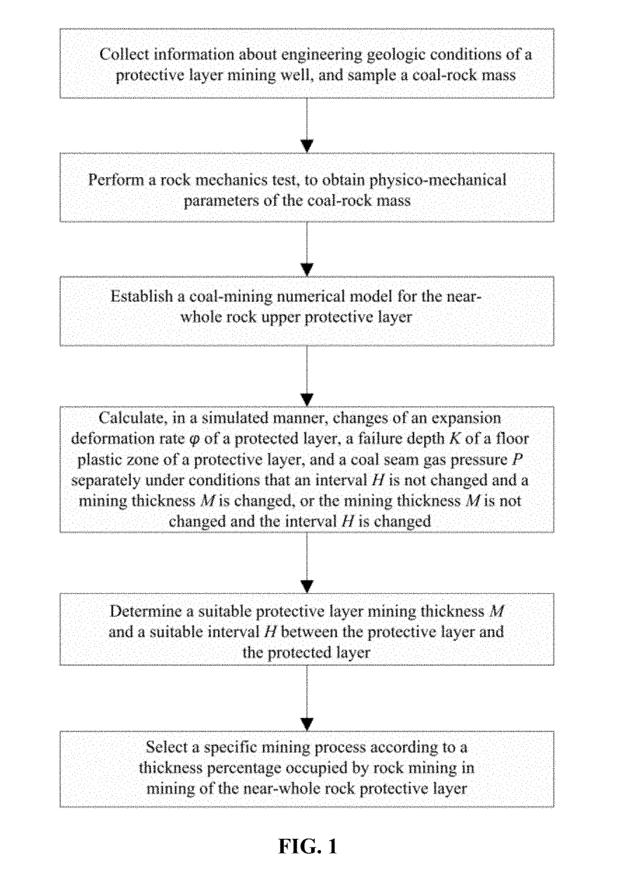

In a mining design method for a near-whole rock upper protective layer of the present invention, based on information about engineering geologic conditions of a protective layer mining well and physico-mechanical parameters of a coal-rock mass sample, and by means of calculation and analysis through numerical simulation, a desired protective layer mining thickness M and a desired interval H between a protective layer and a protected layer are obtained. Then, according to a mining thickness percentage accounted by rock in the near-whole rock upper protective layer, a mining process of the near-whole rock protective layer is determined from among a traditional fully-mechanized coal mining process, a traditional fully-mechanized coal mining process assisted by single-row hole pre-splitting blasting, and a traditional fully-mechanized coal mining process assisted by double-row twisted hole blasting. Referring to FIG. 1, specific steps are as follows:

(1) collecting information about engineering geologic conditions of a protective layer mining well, and sampling a coal-rock mass;

(2) fabricating a standard sample from the sampled coal-rock mass, and performing a rock mechanics test, to obtain physico-mechanical parameters of the coal-rock mass;

(3) according to the information about the engineering geologic conditions of the protective layer mining well and the physico-mechanical parameters of the coal-rock mass, establishing a coal-mining numerical model for the near-whole rock upper protective layer by using finite element analysis software FLAC^{3D};

(4) calculating and analyzing, in a simulated manner, changes of an expansion deformation rate φ of a protected layer, a failure depth K of a floor plastic zone of a protective layer, and a coal seam gas pressure P under respective conditions that an interval H between the protective layer and the protected layer is not changed and a protective layer mining thickness M is changed, or the protective layer mining thickness M is not changed and the interval H between the protective layer and the protected layer is changed;

(5) based on a result of the simulated calculation, determining a desired protective layer mining thickness M and a desired interval H between the protective layer and the protected layer; and

(6) according to a mining thickness percentage accounted by rock in the near-whole rock upper protective layer, determining a mining process of the near-whole rock protective layer from among a traditional fully-mechanized coal mining process, a traditional fully-mechanized coal mining process assisted by single-row hole pre-splitting blasting, and a traditional fully-mechanized coal mining process assisted by twisted hole blasting.

Embodiment 1 Using a coal mine as an example, specific implementation steps are as follows:

(1) Carry out a site survey on a protective layer mining well of the coal mine, collect information about engineering geologic conditions, and sample a coal-rock mass.

(2) Fabricate a standard sample from the sampled coal-rock mass, and perform a rock mechanics test, to obtain physico-mechanical parameters of the coal-rock mass, as shown in Table 1.

TABLE 1

| | | | | | Angle of | | | |
|---|---|---|---|---|---|---|---|---|
| | Shear | Bulk | | Tensile | internal | | Permeability | |
| Rock | modulus | modulus | Cohesion | strength | friction | Density | coefficient | Porosity |
| stratum | /GPa | /GPa | /MPa | /MPa | /° | /kgm⁻³ | (10⁻¹ ms⁻¹) | (%) |
| Sandy | 0.6 | 0.32 | 0.5 | 0.6 | 28 | 1800 | 0.064 | 0.5 |
| mudstone | | | | | | | | |
| layer | | | | | | | | |
| Fine | 1.33 | 1.4 | 2.5 | 2.1 | 30 | 2400 | 0.045 | 10.25 |
| sandstone | | | | | | | | |
| layer | | | | | | | | |
| Sandy | 1.63 | 1.2 | 2.5 | 1.1 | 32 | 2200 | 0.264 | 12.3 |
| mudstone | | | | | | | | |
| layer | | | | | | | | |
| Coal streak | 1.2 | 0.81 | 0.6 | 0.7 | 28 | 1400 | 0.005 | 1.3 |
| Mudstone | 0.6 | 0.32 | 0.5 | 0.6 | 28 | 1600 | 0.004 | 3.8 |
| layer | | | | | | | | |
| Fine | 1.33 | 1.4 | 2.5 | 2.1 | 30 | 2400 | 0.014 | 1.53 |
| sandstone | | | | | | | | |
| layer | | | | | | | | |
| Sandy | 1.63 | 1.2 | 2.5 | 1.1 | 32 | 2200 | 0.007 | 2.6 |
| mudstone | | | | | | | | |
| layer | | | | | | | | |
| Fine | 1.33 | 1.4 | 2.5 | 1.1 | 30 | 2400 | 0.005 | 1.3 |
| sandstone | | | | | | | | |
| layer | | | | | | | | |
| Sandy | 0.6 | 0.32 | 0.5 | 0.6 | 28 | 1800 | 0.045 | 10.25 |
| mudstone | | | | | | | | |
| layer | | | | | | | | |
| Primary | 0.8 | 0.41 | 0.3 | 0.5 | 26 | 1400 | 0.005 | 1.3 |
| mineable | | | | | | | | |
| coal seam | | | | | | | | |
| Mudstone | 0.6 | 0.32 | 0.5 | 0.6 | 28 | 1600 | 0.045 | 5.25 |
| layer | | | | | | | | |
| Fine-grained | 1.63 | 1.2 | 2.5 | 1.1 | 32 | 2400 | 0.1 | 2.73 |
| sandstone | | | | | | | | |
| layer | | | | | | | | |
| Sandy | 0.6 | 0.32 | 0.5 | 0.6 | 28 | 1800 | 0.045 | 10.25 |
| mudstone | | | | | | | | |
| layer | | | | | | | | |

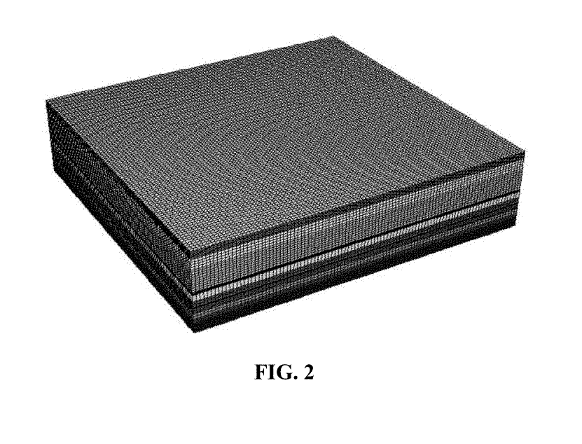

(3) According to the engineering geologic conditions of the protective layer mining well and the physico-mechanical parameters of the coal-rock mass, establish a coal-mining fluid-solid coupling numerical model for the near-whole rock upper protective layer by using numerical simulation software FLAC^{3D}, as shown in FIG. 2.

Length×width×height of the model is 300 m×250 m×100 m. Horizontal displacement is restrained by the surrounding, and the horizontal displacement and perpendicular displacement are restrained by the bottom. The constitutive relation is based on a Mohr-Coulomb model.

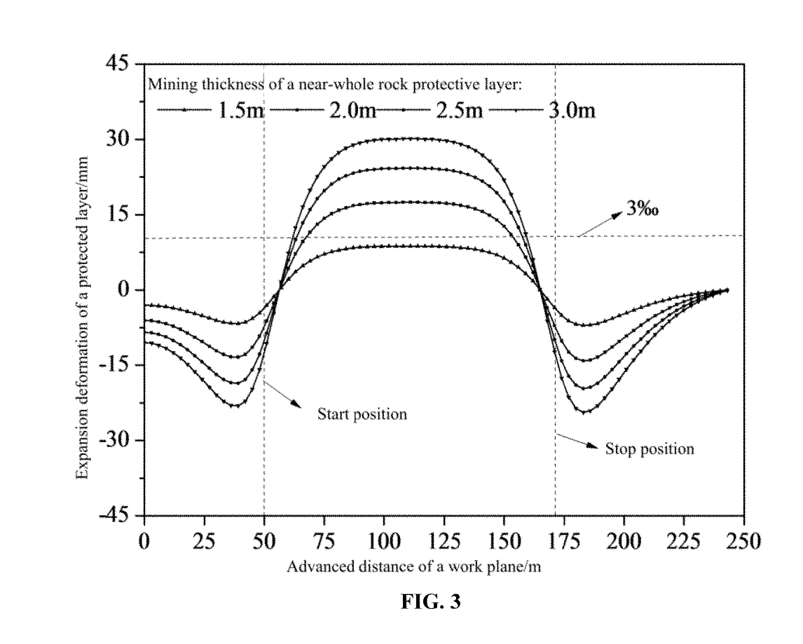

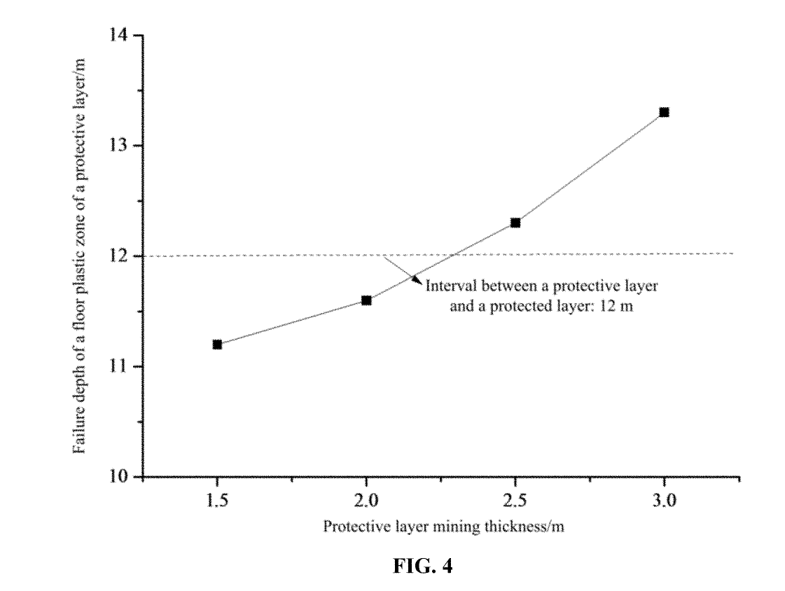

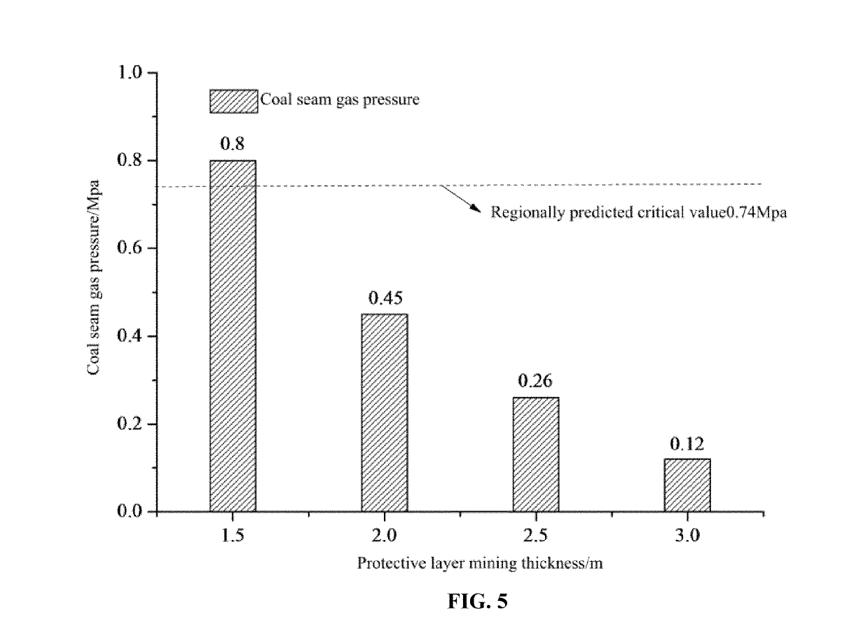

(4) Calculate and analyze, in a simulated manner, changes of an expansion deformation rate φ of a protected layer, a failure depth K of a floor plastic zone of a protective layer, and a coal seam gas pressure P under respective conditions that an interval H between the protective layer and the protected layer is not changed and a protective layer mining thickness M is changed, or the protective layer mining thickness M is not changed and the interval H between the protective layer and the protected layer is changed. A specific simulation solution is shown in Table 2, and the simulation results are shown in FIGS. 3, 4 and 5.

TABLE 2

| Solution | Constant item | Varied item |
|---|---|---|
| I | H = 12 m | M = 1.5 m, 2.0 m, 2.5 m, 3.0 m |
| II | M = 2.0 m | H = 12 m, 20 m, 30 m, 40 m |

(5) Based on the simulation results and after a comprehensive analysis of actual engineering geologic conditions of the mine, determine a protective layer mining thickness to be 2.0 m and an interval between the protective layer and the protected layer to be 12 m.

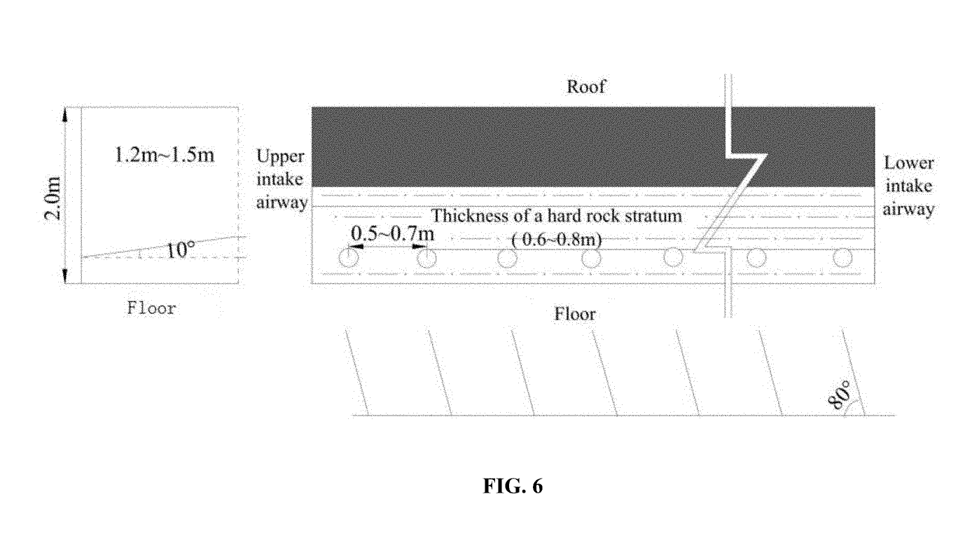

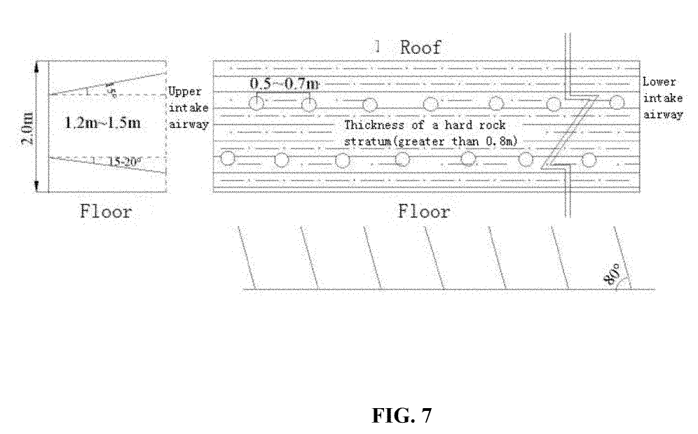

(6) Based on the determined protective layer mining thickness and interval between the protective layer and the protected layer, according to a percentage of a rock stratum in the near-whole rock upper protective layer, direct rock breaking is performed by using a fully-mechanized coal mining process when a thickness of a work-plane rock stratum is below 0.6 m; a traditional fully-mechanized coal mining process assisted by single-row hole pre-splitting blasting is used when a thickness of a work-plane rock stratum is 0.6 m to 0.8 m; and a traditional fully-mechanized coal mining process assisted by double-row twisted hole blasting is used when a thickness of a work-plane rock stratum is above 0.8 m. An arrangement of single-row blast holes and an arrangement of twisted blast holes are shown in FIG. 6 and FIG. 7 respectively.

1. A mining design method for a near-whole rock upper protective layer in coal seam mining, comprising: based on information about engineering geologic conditions of a protective layer mining well and physico-mechanical parameters of a coal-rock mass sample, a protective layer mil g thickness M and an interval H between a protective layer and a protected layer are determined by means of numerical analysis such that an expansion deformation rate φ of the protected layer, a failure depth K of a floor plastic zone of the protective layer, and a coal seam gas pressure P meet the Provision in Prevention and Control of Coal and Gas Outburst; and then, according to a mining thickness percentage accounted by rock in the near-whole rock upper protective layer, a mining process of the near-whole rock protective layer is determined from among a traditional fully-mechanized coal mining process, a traditional fully-mechanized coal mining process assisted by single-row hole pre-splitting blasting, and a traditional fully-mechanized coal mining process assisted by double-row twisted hole blasting; specific steps comprise the following:
(1) collecting information about engineering geologic conditions of the protective layer mining well, and sampling the coal-rock mass;
(2) fabricating a standard sample from the sampled coal-rock mass, and performing a rock mechanics test, to obtain physico-mechanical parameters of the coal-rock mass;
(3) according to the information about the engineering geologic conditions of the protective layer mining well and the physico-mechanical parameters of the coal-rock mass, establishing a coal-mining numerical model for the near-whole rock upper protective layer by using finite element analysis software fast Lagrangian analysis of continua in 3 dimensions (FLAC^{3D});
(4) calculating and analyzing, in a simulated manner, changes of the expansion deformation rate φ of the protected layer, the failure depth K of the floor plastic zone of the protective layer, and the coal seam gas pressure P under respective conditions that the interval H between the protective layer and the protected layer is not changed and the protective layer mining thickness M is changed, or the protective layer mining thickness M is not changed and the interval H between the protective layer and the protected layer is changed;
(5) based on a result of the simulated calculation, determining a desired protective layer mining thickness M and a desired interval H between the protective layer and the protected layer; and
(6) according to a mining thickness percentage accounted by rock in the near-whole rock upper protective layer, determining a mining process of the near-whole rock protective layer from among a traditional fully-mechanized coal mining process, a traditional fully-mechanized coal mining process assisted by single-row hole pre-splitting blasting, and a traditional fully-mechanized coal mining process assisted by double-row twisted hole blasting.

2. The mining design method for a near-whole rock upper protective layer in coal seam mining according to claim 1, wherein the near-whole rock upper protective layer is located above the protected layer, and has a refuse content of up to 80% when a mining thickness of the protective layer is 1.5 m to 3.0 m.
